(19) United States
(12) Patent Application Publication
(10) Pub. No.: US 2007/0179285 A1
(43) Pub. Date: Aug. 2, 2007

(54) Method for producing alkoxy-substituted phthalocyanins

(76) Inventors: Horst Berneth, Leverkusen (DE); Karl-Friedrich Bruder, Krefeld (DE); Karin Hassenruck, Dusseldorf (DE); Oliver Falkner, Koln (DE); Serguei Kostromine, Buschhoven-Swistal (DE); Christa Maria Kruger, Schneverdingen (DE); Timo Meyer-Friedrichsen, Krefeld (DE); Josef-Walter Stawitz, Odenthal (DE); Rafael Oser, Krefeld (DE)

Correspondence Address: Lanxess Corporation;Patent Department, 111 Ridc Park West Drive, Pittsburgh, PA, 15275-1112, US

(21) Appl. No.: 10/562,594

(22) PCT Filed: Jun. 22, 2004
(86) PCT No.: PCT/EP04/06727

§ 371 Date: Nov. 3, 2006

(30) Foreign Application Priority Data
Jul. 2, 2003 (DE) 10329711.1

(51) Int. Cl. C07F 13/00

(52) U.S. Cl. 534/14

(57) ABSTRACT

The invention relates to a process for preparing alkoxy-substituted, metal-containing phthalocyanines of the formula (I) 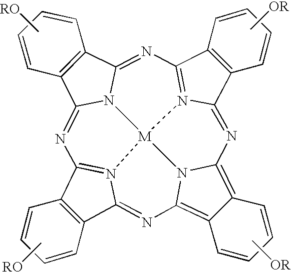 where R is substituted or unsubstituted alkyl or cycloalkyl, M is a divalent metal atom, metaloxy or a trivalent or tetravalent substituted metal atom,
characterized in that the phthalonitrile of the formula (II) 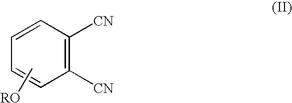 is reacted in the presence of a metal salt and a base in a water-miscible solvent.

The present invention relates to a process for preparing alkoxy-substituted, metal-containing phthalocyanines, and to the phthalocyanines obtainable in this way.

Alkoxy-substituted phthalocyanines are important light-absorbent compounds which are used in the information layer of optical data carriers. The preparation of alkoxy-substituted phthalocyanines has been described, for example, in EP-A 703 280, in which the preparation is carried out by reaction of alkoxy-substituted dinitriles in the presence of a metal salt, a Lewis acid and urea in nitrobenzene, nitrotoluene or nitroxylene. However, this method of preparation has the disadvantage that isolation has to be carried out by evaporation of the solution and the residues which remain are difficult to handle.

It is an object of the present invention to provide an improved process for preparing such phthalocyanines.

The invention accordingly provides a process for preparing metal-containing phthalocyanines of the formula (I) 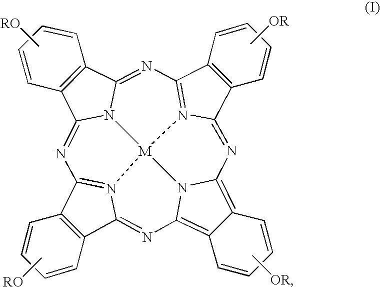
where
R is substituted or unsubstituted alkyl or cycloalkyl,
M is a divalent metal atom, metaloxy or a trivalent or tetravalent substituted metal atom,
characterized in that the phthalonitrile of the formula (II) 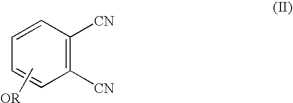
is reacted in the presence of a metal salt and a base in a water-miscible solvent.

In a preferred embodiment of the process of the invention, the alkyl or cycloalkyl radical may bear further radicals such as halogen, hydroxy, hydroxyalkyl, amino, alkylamino, dialkylamino, nitro, cyano, CO—NH₂, alkoxy, alkoxycarbonyl, morpholino, piperidino, pyrrolidino, pyrrolidono, trialkylsilyl, trialkylsiloxy or substituted or unsubstituted phenyl. The alkyl radical may also be substituted by a cycloalkyl radical and the cycloalkyl radical by an alkyl radical. The alkyl or cycloalkyl radical may be saturated, unsaturated, linear or branched, and can be partially halogenated or perhalogenated or can be ethoxylated, propoxylated or silylated.

“Alkyl” substituents are preferably C₁-C₁₆-alkyl, in particular C₁-C₁₂-alkyl, particularly preferably C₁-C₈-alkyl, each of which may be substituted by halogen such as chlorine, bromine or fluorine, hydroxy, cyano and/or C₁-C₆-alkoxy.

“Cycloalkyl” substituents are preferably C₃-C₁₂-cycloalkyl, in particular C₅-C₈-cycloalkyl, each of which may be substituted by halogen such as chlorine, bromine or fluorine, hydroxy, cyano and/or C₁-C₆-alkoxy.

In a particularly preferred embodiment, the radical
R is methyl, ethyl, propyl, isopropyl, butyl, isobutyl, tert-butyl, pentyl, 3-(2,4-dimethyl)pentyl, tert-amyl, hexyl, heptyl, octyl, nonyl, decyl, undecyl, dodecyl, ethylhexyl, hydroxyethyl, methoxyethyl, ethoxyethyl, 3-(2-ethylhexyloxy)propyl, methoxyethoxypropyl, methoxyethoxyethyl, 3-dimethylaminopropyl, 3-diethyl-aminopropyl, cyclopentyl, cyclohexyl, phenylcyclohexyl or cyclooctyl, in particular 3-(2,4-dimethyl)pentyl.

Preference is given to
M being Cu, Zn, Fe, Ni, Ru, Rh, Pd, Pt, Mn, Mg, Be, Ca, Ba, Cd, Hg, Sn, Co, Pb, VO, MnO, TiO, FeCl, AlCl, GaCl, InCl, AlBr, GaBr, InBr, AlI, GaI, InI, AlF, GaF, InF, SiCl₂, GeCl₂ or SnCl₂, in particular Co.

Particular preference is given to using phthalonitriles of the formula (IIa)

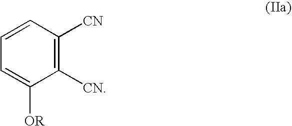

Preference is likewise given to preparing phthalocyanines of the formula (I) which correspond to the formula (Ia) 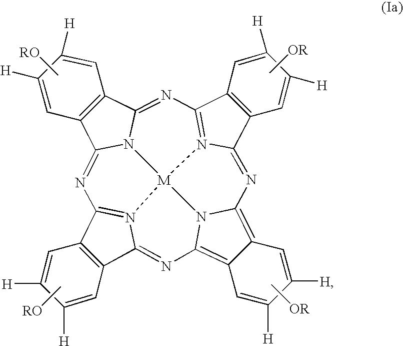
where
M is Co and
R is as defined above, in particular is 2-ethylhexyl or 2,4-dimethyl-3-pentyl.

Suitable solvents are, for example, DMF, NMP, DMSO, ε-caprolactam, sulpholane, 1,3-dimethyl-2-imidazolidinone or mixtures thereof.

As base, preference is given to using 1,5-diazabicyclo[4.3.0]non-5-ene (DBN), 1,5-diazabicyclo[5.4.0]undec-5-ene, 1,4-diazabicyclo[2.2.2]octane, ammonia, morpholine, piperidine, pyridine, picoline or C₁-C₁₂-alkoxides and also mixtures thereof.

Preferred metal salts are halides, e.g. chlorides or bromides, and also oxyhalides, acetates, acetylacetonates, oxides, sulphates, carbonates and hydroxides and also mixtures thereof.

Sparingly soluble metal salts or oxides can, for example, be converted into soluble acetates by means of glacial acetic acid.

If desired, concomitant use can be made of ammonium molybdate or ammonium molybdate tetrahydrate.

The reaction is preferably carried out at a temperature of from 120° C. to 250° C., in particular from 130° C. to 190° C.

The reaction is preferably carried out in the presence of an inert gas atmosphere, for example N₂ or argon.

The subsequent isolation of I is carried out, in particular, by addition of water, resulting in precipitation of the dye which can be filtered off.

Phthalocyanines are preferably obtained as an isomer mixture of the formula (I). The isomers preferably correspond to those of the formulae (Iw), (Ix), (Iy) and (Iz) 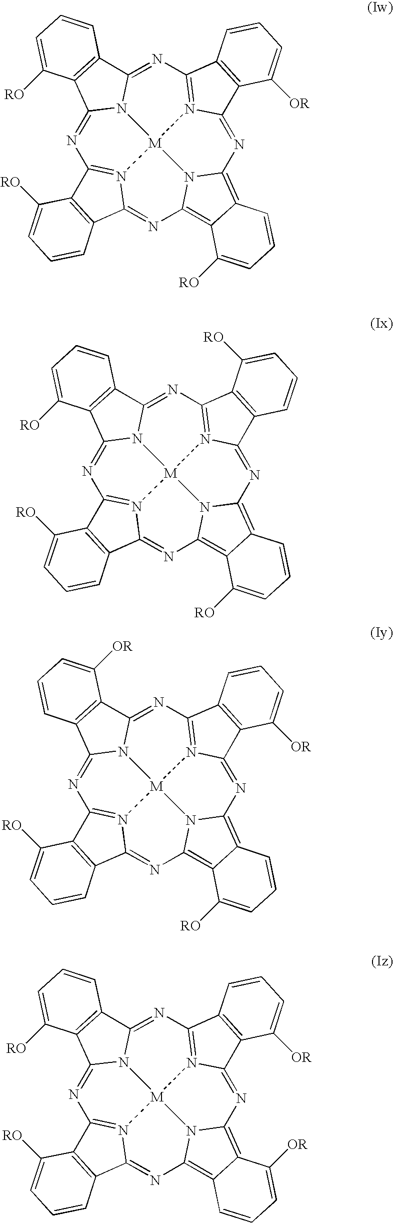
where
R and M are as defined above.

The process of the invention is particularly preferably used to produce an isomer mixture in which the proportion of the isomers of the formulae (Iy) and (Iz) together is greater than or equal to 20% by weight of the sum of the isomers of the formula (I).

The invention further provides an isomer mixture comprising at least 20% by weight of the two isomers of the formulae (Iy) and (Iz), based on the sum of the isomers of the formula (I), where M and R are as defined above and M and R preferably have the meanings given for the formula (Ia).

The isomer mixture of the invention can be used as light-absorbent compound in the information layer of an optical data carrier. Its use and also such an optical data carrier itself are thus also subject matter of the invention.

The isomer mixture of the invention is preferably suitable for producing optical data carriers on which the information can be read and written by means of, in particular, an IR laser.

The invention therefore also provides optical data carriers comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on and read by means of infrared light, preferably laser light, particularly preferably light having a wavelength in the range 750-800 nm, in particular 770-790 nm, where the information layer comprises a light-absorbent compound and, if desired, a binder, characterized in that at least one phthalocyanine isomer mixture according to the invention is used as light-absorbent compound.

The invention further relates to the use of phthalocyanines according to the invention as light-absorbent compounds in the light-writable information layer of optical data stoves.

The isomer mixture of the invention can, however, also be used for preparing further phthalocyanines, for example ones which have further ligands coordinated to the metal centre.

### EXAMPLES

### Example 1

187 g of 3-(2-ethylhexoxy)phthalonitrile and 29.8 g of cobalt(II) hydroxide are added to 1 l of NMP at room temperature (RT). 38 g of glacial acetic acid are then added and the mixture is stirred at 60° C. for 10 minutes. 130 ml of DBN are then added and the mixture is warmed quickly to 180° C. and stirred for 3 hours at 180° C. After cooling slowly to 120° C., 110 ml of water are added and the mixture is stirred at 100° C. for 30 minutes. It is then cooled to 70° C. and 720 ml of methanol are added. It is slowly cooled to RT overnight and 260 ml of water are slowly added dropwise over a period of 120 minutes. The pH is 11.5 and is brought to pH 7.5 by means of aqueous HCl. After stirring for another 10 minutes, the mixture is filtered with suction, the paste is washed with a total of 500 ml of methanol in portions of about 100 ml and dried at 30° C. under reduced pressure.

Yield: 123.4 g (\hat{=}62% of theory); λₘₐₓ 702 nm (NMP) of a phthalocyanine of the following formulae (isomers): 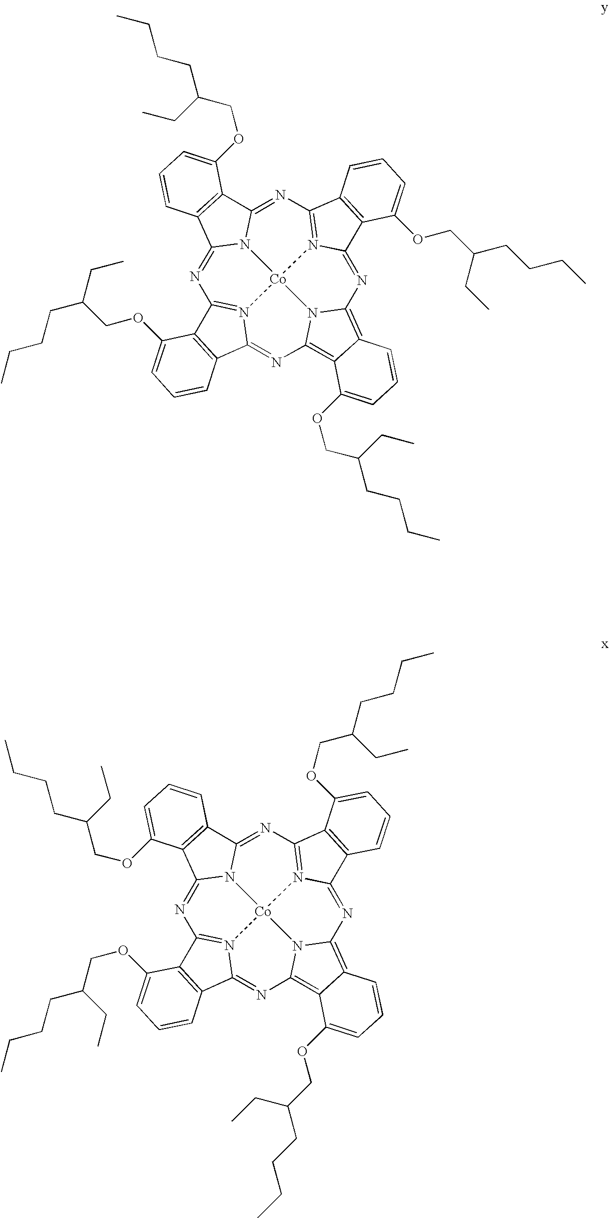 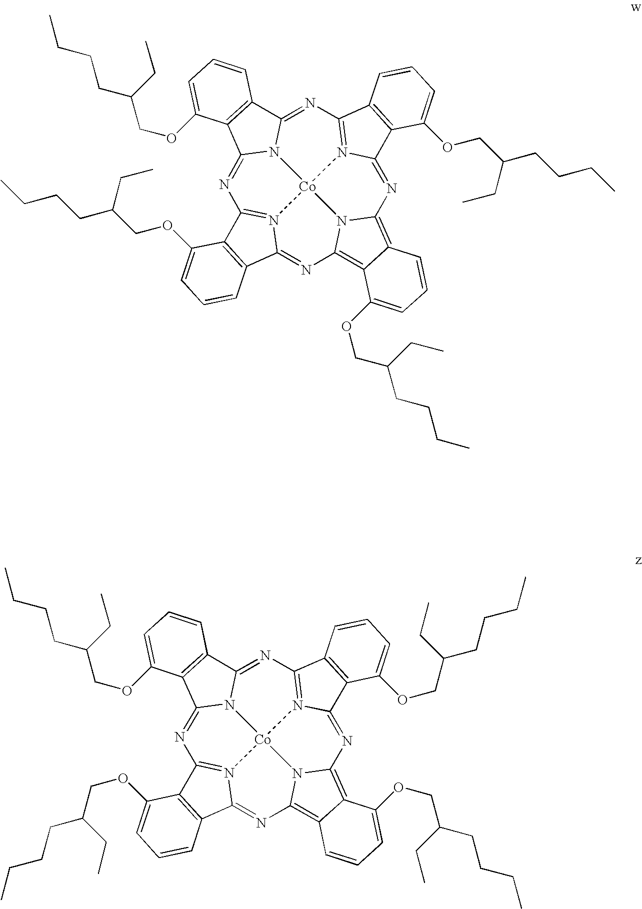
where the isomers have the following weight distribution: y+z=25% by weight, w+x=75% by weight, based on the total amount of phthalocyanine produced.

### Example 2

176.8 g of 3-(2,4-dimethyl-3-pentoxy)phthalonitrile and 29.8 g of cobalt(II) hydroxide are melted with 1120 g of epsilon-caprolactam at 60° C. When the melt is homogeneous, 38 g of glacial acetic acid are added and the mixture is stirred at 60° C. for another 10 minutes. 149.3 ml of DBU are then added and the mixture is heated quickly to 180° C. and stirred for 4 hours at 180° C. After slowly cooling to 130° C., 110 ml of water are added and the mixture is stirred at 100° C. for 30 minutes. It is then cooled to 70° C. and 720 ml of methanol are added. It is cooled slowly to RT overnight and 260 ml of water are slowly added dropwise over a period of 120 minutes. The pH is 11.5 and is brought to pH 7.5 by means of aqueous HCl. After stirring for another 10 minutes, the mixture is filtered with suction, the paste is washed with a total of 500 ml of methanol in portions of about 100 ml and dried at 30° C. under reduced pressure.

Yield: 116.3 g (\hat{=}61% of theory); λₘₐₓ 703 nm (NMP) of a phthalocyanine of the following formulae (isomers): 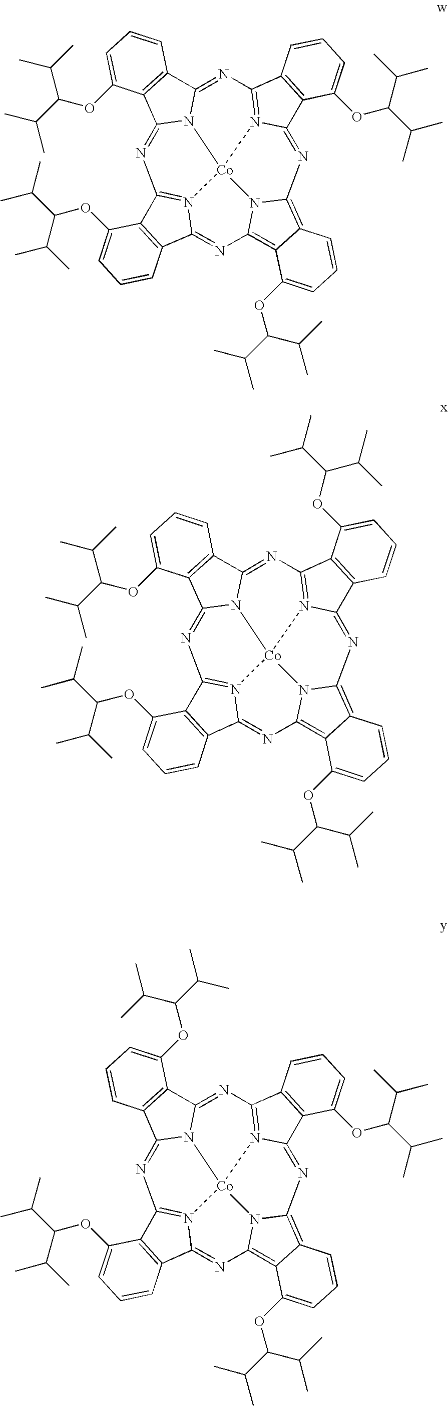 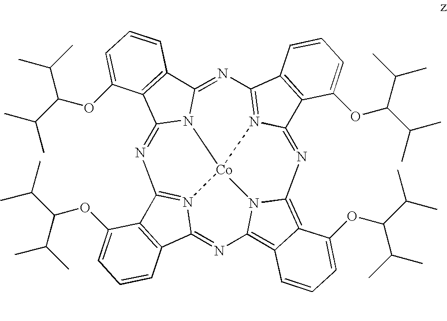
where the isomers have the following weight distribution: y+z=22% by weight, w+x=78% by weight, in each case based on the total amount of phthalocyanine produced.

### Comparative Example (Example 1 from EP-A 703 280)

50 g of 3-(2,4-dimethyl-3-pentyloxy)phthalonitrile, 9.1 g of anhydrous palladium chloride, 24.8 g of urea and 1 g of ammonium molybdate are added to 200 ml of nitrobenzene and the mixture is heated to 160° C. while stirring under an argon atmosphere. The mixture is subsequently stirred at this temperature for 4 hours, then cooled to RT, diluted with toluene and filtered through a filter aid. The filtrate is evaporated completely at 100° C./10⁻¹ mbar. The residue is taken up in 400 ml of toluene and filtered through 500 g of silica gel using toluene as eluant. The toluene phase is concentrated by evaporation and subsequently added dropwise to 1.5 l of methanol. The precipitate is filtered off and washed twice with 100 ml of methanol. It is then dried at 60° C./165 mbar for 12 hours. This gives 32.5 g (=59% of theory) of a greenish blue dye having a γₘₐₓ of 702 nm (NMP). The process of the invention enables a palladium phthalocyanine to be prepared using the same starting materials in a manner analogous to Example 1 with considerably fewer technical complications.

1. Process for preparing alkoxy-substituted, metal-containing phthalocyanines of the formula (I) 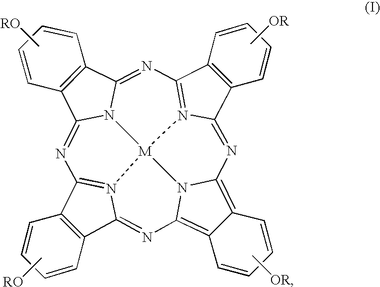
where
R is substituted or unsubstituted alkyl or cycloalkyl,
M is a divalent metal atom, metaloxy or a trivalent or tetravalent substituted metal atom,
characterized in that the phthalonitrile of the formula (II) 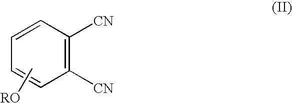
is reacted in the presence of a metal salt and a base in a water-miscible solvent.

2. Process according to claim 1, wherein the solvent used is DMF, NMP, DMSO, caprolactam or a mixture thereof.

3. Process according to claim 1, characterized in that
R is methyl, ethyl, propyl, isopropyl, butyl, isobutyl, tert-butyl, pentyl, 3-(2,4-dimethyl)pentyl, tert-amyl, hexyl, heptyl, octyl, nonyl, decyl, undecyl, dodecyl, ethylhexyl, hydroxyethyl, methoxyethyl, ethoxyethyl, 3-(2-ethylhexyloxy)propyl, methoxyethoxypropyl, methoxyethoxyethyl, 3-dimethylaminopropyl, 3-di-ethylaminopropyl, cyclopentyl, cyclohexyl, phenylcyclohexyl or cyclooctyl, in particular 3-(2,4-dimethyl)pentyl.

4. Process according to claim 1, characterized in that
M is Cu, Zn, Fe, Ni, Ru, Rh, Pd, Pt, Mn, Mg, Be, Ca, Ba, Cd, Hg, Sn, Co, Pb, VO, MnO, TiO, FeCl, AlCl, GaCl, InCl, AlBr, GaBr, InBr, AlI, GaI, InI, AlF, GaF, InF, SiCl₂, GeCl₂ or SnCl₂.

5. Process according to claim 1, characterized in that the reaction is carried out at a temperature of from 130° C. to 190° C.

6. Process according to claim 1, characterized in that the base used is 1,5-diazabicyclo[4.3.0]non-5-ene, 1,5-diazabicyclo[5.4.0]undec-5-ene, 1,4-diaza-bicyclo[2.2.2]octane, ammonia, morpholine, piperidine, pyridine, picoline, a C₁-C₁₂-alkoxide or a mixture thereof.

7. Isomer mixture comprising at least 20% by weight of the isomers (Iy) and (Iz), based on the sum of the isomers of the formula (I) 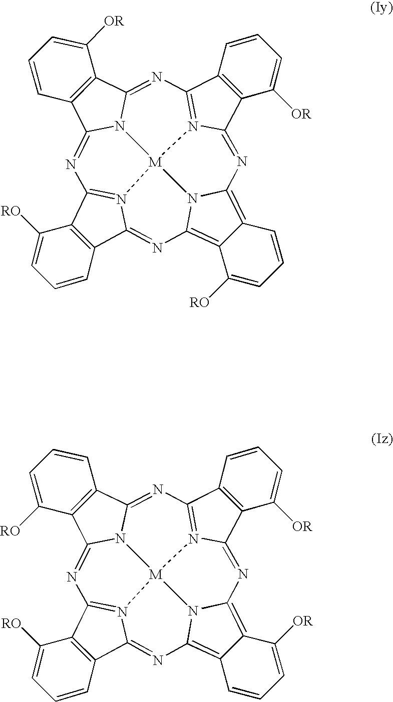
where
M and R are as defined in claim 1.

8. Optical data carrier comprising a preferably transparent substrate which may, if desired, have previously been coated with one or more reflection layers and to whose surface a light-writable information layer, if desired one or more reflection layers and if desired a protective layer or a further substrate or a covering layer have been applied, which can be written on and read by means of infrared light, preferably laser light, particularly preferably light having a wavelength in the range 750-800 nm, in particular 770-790 nm, where the information layer comprises a light-absorbent compound and, if desired, a binder, characterized in that at least one phthalocyanine isomer mixture according to claim 7 is used as light-absorbent compound.

9. Use of phthalocyanine isomer mixtures according to claim 7 as light-absorbent compounds in the light-writable information layer of optical data stores.
